(19) United States
(12) Patent Application Publication
(10) Pub. No.: US 2026/0064880 A1
(43) Pub. Date: Mar. 5, 2026

(54) CLOUD SYSTEM

(71) Applicant: KYOCERA Document Solutions Inc., , Osaka (JP)

(72) Inventors: Ayaka Suzuki, Osaka (JP); Takeshi Nakamura, Osaka (JP)

(21) Appl. No.: 19/313,448

(22) Filed: Aug. 28, 2025

(30) Foreign Application Priority Data
Aug. 30, 2024 (JP) 2024-150311
Aug. 30, 2024 (JP) 2024-150312

(51) Int. Cl. G06F 21/62

(52) U.S. Cl. CPC G06F 21/6245

(57) ABSTRACT

A service providing system, in a case in which user information in an authentication request for accessing a specific tenant transmitted from a specific client exists in user management information in association with the target tenant, and client information in the authentication request does not exist in the client management information in association with the target tenant, and this client information exists in issued information management information, adds this client information to the client management information in association with the target tenant, and notifies the client of an access token.

### INCORPORATION BY REFERENCE

This application is based upon and claims the benefit of priority from the corresponding Japanese Patent Application No. 2024-150311 and 2024-150312 filed on Aug. 30, 2024, the entire contents of which are incorporated herein by reference.

The present disclosure relates to a cloud system in which a tenant is accessed using an access token, an information processing apparatus, and a program storage medium for a cloud system.

### BACKGROUND

Conventionally, cloud systems are known in which a tenant is accessed using an access token.

### SUMMARY

The cloud system according to the present disclosure is a cloud system that uses user management information for managing user information as information about users for each tenant; client management information for managing client information as information about a client for each tenant; and issued information management information for managing the issued client information; and is configured to notify a specific client of an access token in a case in which a request for accessing a specific tenant is transmitted from the specific client and when the user information in the request exists in the user management information in association with the tenant that is a target of the request and the client information in the request exists in the client management information in association with the tenant that is the target of the request; and notify the specific client of the access token when the client information in the request exists in the issued information management information even in a case in which the user information in the request exists in the user management information in association with the tenant that is the target of the request, but the client information in the request does not exist in the client management information in association with the tenant that is the target of the request.

The cloud system according to the present disclosure, in a case in which the client information in the request does not exist in the client management information in association with the tenant that is the target of the request, and when the user information in the request exists in the user management information in association with the tenant that is the target of the request, and the client information in the request exists in the issued information management information, may add the client information in the request to the client management information in association with the tenant that is the target of the request.

The program storage medium for a cloud system according to the present disclosure is a non-transitory computer-readable storage medium that stores the cloud system program. The cloud system program makes a computer to function as a cloud system that uses user management information for managing user information as information about users for each tenant; client management information for managing client information as information about a client for each tenant; and issued information management information for managing the issued client information; and is configured to notify a specific client of an access token in a case in which a request for accessing a specific tenant is transmitted from the specific client and when the user information in the request exists in the user management information in association with the tenant that is a target of the request and the client information in the request exists in the client management information in association with the tenant that is the target of the request; and notify the specific client of the access token when the client information in the request exists in the issued information management information even in a case in which the user information in the request exists in the user management information in association with the tenant that is the target of the request, but the client information in the request does not exist in the client management information in association with the tenant that is the target of the request.

The cloud system according to the present disclosure is a cloud system that uses user management information for managing user information as information about users for each tenant; client management information for managing client information as information about a client for each tenant; and issued information management information for managing the issued client information; and is configured to notify the specific client of a URL of an input screen for the user information in a case in which a request for accessing the specific tenant is transmitted from the specific client and the client information in the request exists in the client management information is in association with the tenant that is the target of the request; notify the specific client of the URL in a case in which the client information in the request exists in the issued information management information even when the client information in the request does not exist in the client management information in association with the tenant that is the target of the request; and notify the specific client of an access token in a case in which the user information entered on the input screen exists in the user management information in association with the tenant that is the target of the request.

The cloud system according to the present disclosure, in a case in which the client information in the request does not exist in the client management information in association with the tenant that is the target of the request, and when the client information in the request exists in the issued information management information, and the user information entered on the input screen exists in the user management information in association with the tenant that is the target of the request, may add the client information in the request to the client management information in association with the tenant that is the target of the request.

The program storage medium for a cloud system according to the present disclosure is a non-transitory computer-readable storage medium that stores the cloud system program. The cloud system program makes a computer to function as a cloud system that uses user management information for managing user information as information about users for each tenant; client management information for managing client information as information about a client for each tenant; and issued information management information for managing the issued client information; and is configured to notify the specific client of a URL of an input screen for the user information in a case in which a request for accessing the specific tenant is transmitted from the specific client and the client information in the request exists in the client management information in association with the tenant that is the target of the request; notify the specific client of the URL in a case in which the client information in the request exists in the issued information management information even when the client information in the request does not exist in the client management information in association with the tenant that is the target of the request; and notify the specific client of an access token in a case in which the user information entered on the input screen exists in the user management information in association with the tenant that is the target of the request.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram of a system of a first embodiment according to the present disclosure.

FIG. 2 is a block diagram of an example of a service providing system shown in FIG. 1 when configured by one computer.

FIG. 3 is a diagram showing an example of tenant management information illustrated in FIG. 2.

FIG. 4 is a diagram showing an example of user management information shown in FIG. 2.

FIG. 5 is a diagram showing an example of client management information shown in FIG. 2.

FIG. 6 is a diagram showing an example of issued information management information shown in FIG. 2.

FIG. 7 is a diagram showing an example of token management information illustrated in FIG. 2.

FIG. 8 is a block diagram of an example of a user terminal shown in FIG. 1.

FIG. 9 is a sequence diagram of an operation of the system shown in FIG. 1 when a user terminal accesses a specific tenant of the service providing system.

FIG. 10 is a flowchart showing an operation of an API interface portion of the service providing system shown in FIG. 2 when an authentication request is received.

FIG. 11 is a flowchart showing an operation of an authentication server of the service providing system shown in FIG. 2 when an intra-system authentication request is received.

FIG. 12 is a diagram illustrating an example of the user information determination process shown in FIG. 10.

FIG. 13 is a diagram showing an example of client management information that is different from the example shown in FIG. 5.

FIG. 14 is a diagram showing an example of issued information management information that is different from the example shown in FIG. 6.

FIG. 15 is a block diagram of a system of a second embodiment according to the present disclosure.

FIG. 16 is a diagram showing an example of the authorization code management information shown in FIG. 15.

FIG. 17 is a sequence diagram of an operation of the system shown in FIG. 1 when a user terminal accesses a specific tenant of the service providing system.

FIG. 18 is a flowchart of the operation of the API interface portion of the service providing system shown in FIG. 15 when an authorization code request is received.

FIG. 19 is a diagram showing an example of client management information that is different from the examples shown in FIG. 5 and FIG. 13.

FIG. 20 is a diagram showing an example of issued information management information that is different from the examples shown in FIG. 6 and FIG. 14.

FIG. 21 is a diagram showing an example of a user authorization screen displayed in the operation shown in FIG. 17.

FIG. 22 is a flowchart showing operation of the authentication server of the service providing system shown in FIG. 15 when a combination of a user ID and a password is received.

FIG. 23 is a flowchart of operation of the API interface portion of the service providing system shown in FIG. 15 when an authentication request is received.

FIG. 24 is a diagram showing an example of a state determination process shown in FIG. 23.

FIG. 25 is a flowchart showing operation of the authentication server of the service providing system shown in FIG. 15 when an intra-system authentication request is received.

### DETAILED DESCRIPTION

### First Embodiment

Hereinafter, a first embodiment according to the present disclosure will be described with reference to the drawings.

First, a configuration of a system of the first embodiment according to the present disclosure will be described.

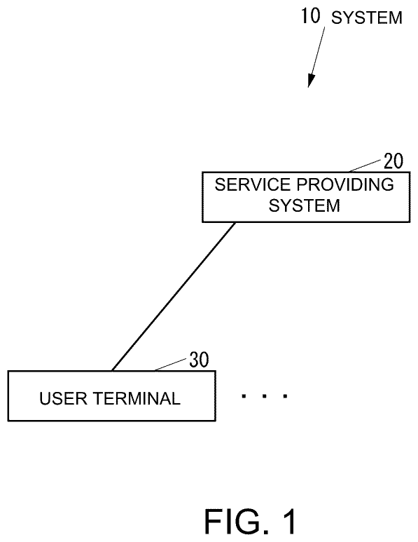

FIG. 1 is a block diagram of a system 10 according to the present embodiment.

As shown in FIG. 1, the system 10 includes a service providing system 20 serving as a cloud system that provides cloud services that are utilized by user terminals used by users. The service providing system 20 may be composed of a single computer such as a personal computer (PC), or may be composed of a plurality of computers. The service providing system 20 is configured on a cloud.

The system 10 includes a user terminal 30 that is used by a user. The system 10 may include at least one other user terminal having a similar configuration to the user terminal 30. The user terminal may, for example, be configured by a computer such as a PC.

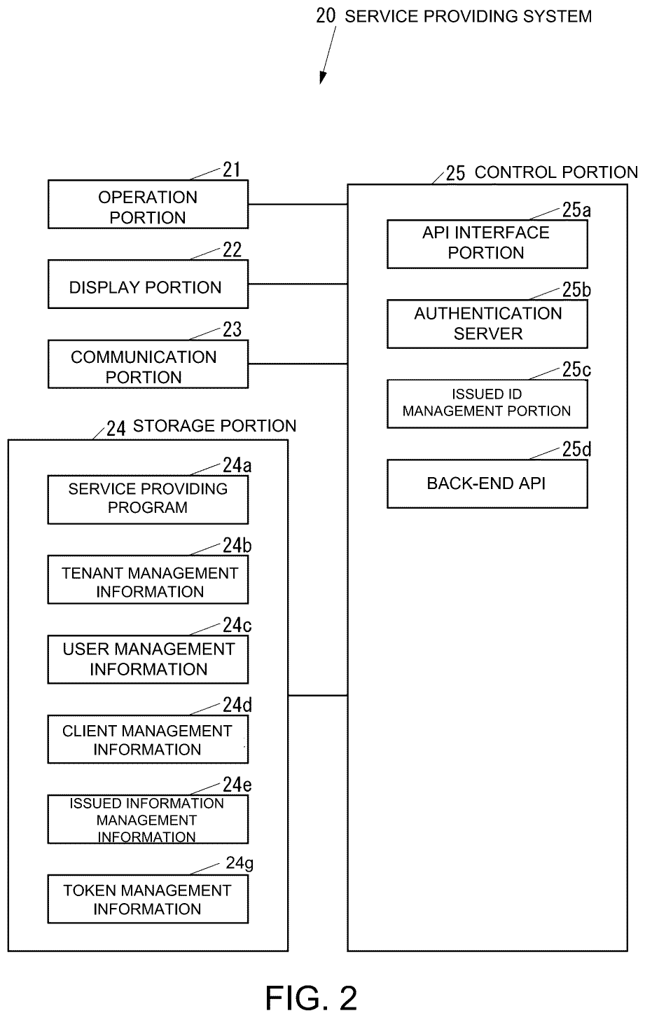

FIG. 2 is a block diagram of an example of a service providing system 20 configured by one computer.

As shown in FIG. 2, the service providing system 20 includes: an operation portion 21 that is an operating device such as a keyboard or mouse through which various types of operations are input; a display portion 22 that is a display device such as a liquid crystal display (LCD) that displays various types of information; a communication portion 23 that is a communication device that communicates with external devices via a network such as a local area network (LAN) or the Internet, or directly by wire or wirelessly without using a network; a storage portion 24 that is a non-volatile memory device such as a semiconductor memory or hard disk drive (HDD) that stores various types of information; and a control portion 25 that controls the entire service providing system 20.

The storage portion 24 can store a service providing program 24a as a cloud system program for providing cloud services. The service providing program 24a may, for example, be installed in the service providing system 20 during the manufacturing stage of the service providing system 20, or may be additionally installed in the service providing system 20 from an external storage medium such as a universal serial bus (USB) memory, or may be additionally installed in the service providing system 20 from a network.

The storage portion 24 is capable of storing tenant management information 24b that manages tenants of the service providing system 20. The tenant management information 24b may be configured as a database.

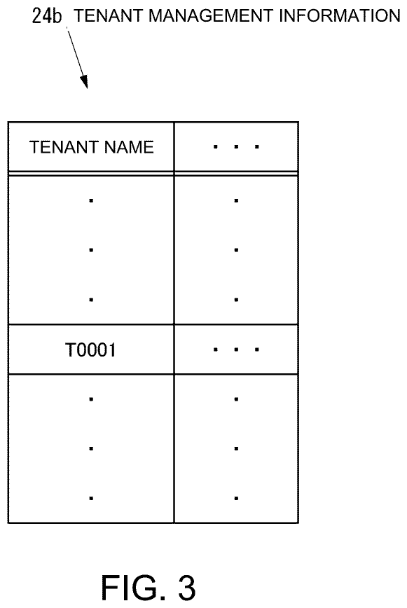

FIG. 3 is a diagram showing an example of the tenant management information 24b.

As shown in FIG. 3, the tenant management information 24b includes, for each tenant, a tenant name as identification information of the tenant. The tenant management information 24b shown in FIG. 3 is shown with some information omitted.

As shown in FIG. 2, the storage portion 24 can store user management information 24c that manages users who belong to tenants of the service providing system 20. The user management information 24c may be configured as a database.

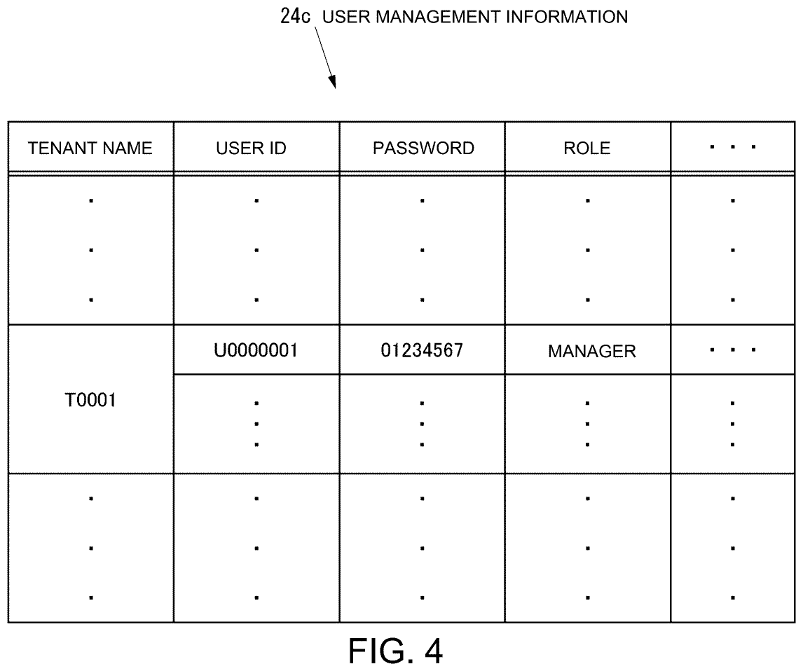

FIG. 4 is a diagram showing an example of the user management information 24c.

As shown in FIG. 4, the user management information 24c includes the tenant name of the tenant to which a user belongs, a user ID as identification information for the user, a password of the user, and a role of the user for each combination of tenant and user. The combination of the user ID and the password constitutes user information, which is information about a user. The roles include administrator, and general user for a general user. The user management information 24c shown in FIG. 4 is shown with some information omitted.

As shown in FIG. 2, the storage portion 24 can store client management information 24d that manages clients to which the service providing system 20 issues access tokens. The client management information 24d may be configured as a database. The client may be manufactured by a manufacturer of the service providing system 20, or may be manufactured by a manufacturer other than the manufacturer of the service providing system 20.

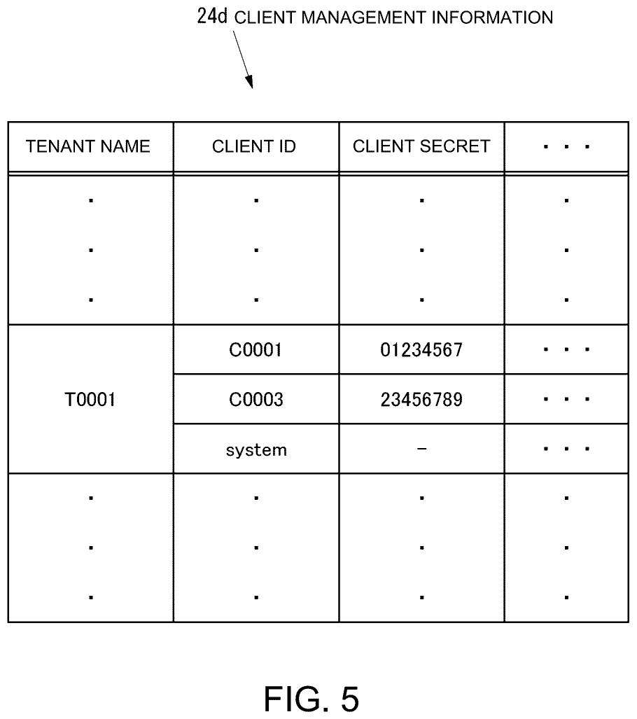

FIG. 5 is a diagram showing an example of client management information 24d.

As shown in FIG. 5, the client management information 24d includes, for each combination of tenant and client, the tenant name of the tenant to which the client is associated, a client ID as identification information for the client, and a client secret used to authenticate the client by the service providing system 20. The client ID constitutes at least a part of the client information. The client secret may not be set. The client secret, when set, constitutes part of the client information. In the client management information 24d, the client ID of the service providing system 20 is registered for all tenants. The client ID of the service providing system 20 is, for example, “system”. In the value of the client secret in the client management information 24d shown in FIG. 5, “−” indicates that the client secret is not set. The client management information 24d shown in FIG. 5 is shown with some information omitted.

The client ID and the client secret may be issued, for example, by the operator of the service providing system 20. The same client ID may be issued to clients manufactured by the same manufacturer regardless of the type of client, or different client IDs may be issued for each type of client even though the clients are manufactured by the same manufacturer.

As shown in FIG. 2, the storage portion 24 can store issued information management information 24e that manages issued client information. The issued information management information 24e may be configured as a database.

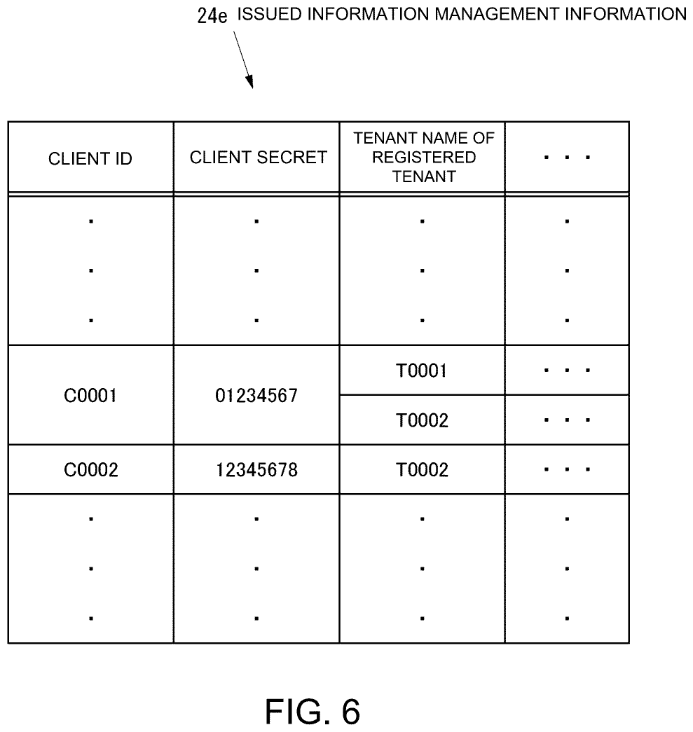

FIG. 6 is a diagram showing an example of issued information management information 24e.

As shown in FIG. 6, the issued information management information 24e includes, for each client and client ID, a client ID, a client secret, and a tenant name of a tenant whose client ID has been registered in the client management information 24d. The issued information management information 24e shown in FIG. 6 is shown with some information omitted.

As shown in FIG. 2, the storage portion 24 is capable of storing token management information 24g that manages access tokens issued by the service providing system 20. The token management information 24g may be configured as a database.

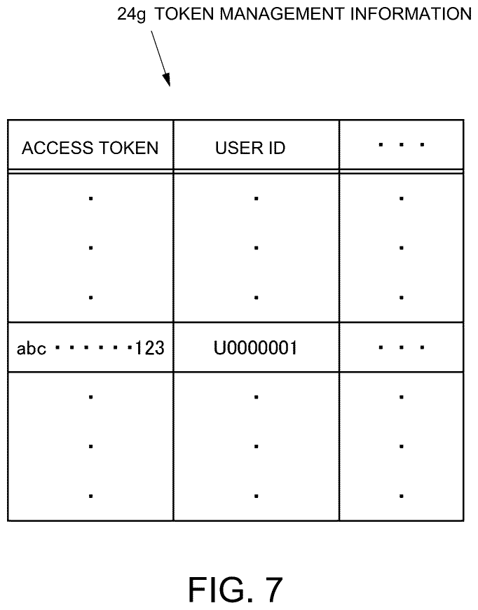

FIG. 7 is a diagram showing an example of token management information 24g.

As shown in FIG. 7, the token management information 24g includes, for each access token, an access token and a user ID of a user to whom the access token is assigned. The token management information 24g shown in FIG. 7 is shown with some information omitted.

The control portion 25 shown in FIG. 2 includes, for example, a central processing unit (CPU), a read only memory (ROM) that stores programs and various types of data, and a random access memory (RAM) that serves as a memory used as a working area for the CPU of the control portion 25. The CPU of the control portion 25 executes a program stored in the storage portion 24 or the ROM of the control portion 25.

By executing the service providing program 24a, the control portion 25 achieves functioning as: an API interface portion 25a that receives application programming interface (API) requests from clients, an authentication server 25b that performs authentication, an issued ID management portion 25c that manages issued client IDs, and a back-end API 25d that executes APIs other than authentication.

The issued ID management portion 25c is capable of editing the issued information management information 24e in response to an instruction from a specific user. For example, the issued ID management portion 25c can add a new client ID to the issued information management information 24e, delete a specific client ID from the issued information management information 24e, set a new client secret for a specific client ID in the issued information management information 24e, change a client secret associated with a specific client ID in the issued information management information 24e, and delete a client secret associated with a specific client ID in the issued information management information 24e.

It is possible to employ various function as functions to be executed by the back-end API 25d. For example, the functions executed by the back-end API 25d may include downloading a document from the service providing system 20 to a user terminal, and uploading a document from the user terminal to the service providing system 20.

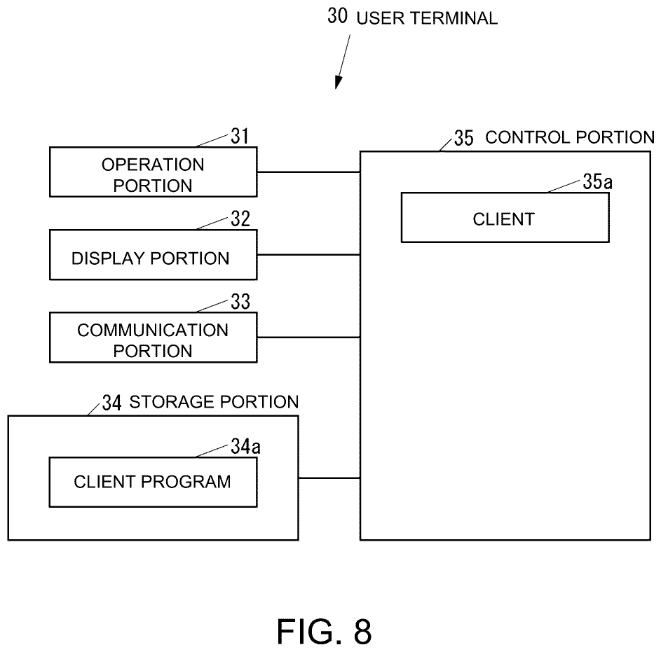

FIG. 8 is a block diagram of an example of the user terminal 30.

As shown in FIG. 8, the user terminal 30 is equipped with an operation portion 31 that is an operation device such as a keyboard or mouse through which various operations are input, a display portion 32 that is a display device such as an LCD that displays various information, a communication portion 33 that is a communication device that performs communication with external devices via a network such as a LAN or the Internet, or directly via a wired or wireless connection without going through a network, a storage portion 34 that is a non-volatile memory device such as a semiconductor memory or HDD that stores various types of information, and a control portion 35 that controls the entire user terminal 30.

The storage portion 34 is capable of storing a client program 34a for a client. The client program 34a may, for example, be installed on the user terminal 30 during the manufacturing stage of the user terminal 30, or may be additionally installed on the user terminal 30 from an external storage medium such as a USB memory, or may be additionally installed on the user terminal 30 from a network.

The control portion 35 includes, for example, a CPU, a ROM that stores programs and various types of data, and a RAM as a memory used as a working area for the CPU of the control portion 35. The CPU of the control portion 35 executes a program stored in the storage portion 34 or the ROM of the control portion 35.

The control portion 35 executes the client program 34a to achieve a function of a client 35a.

Conventionally, cloud systems are known in which a tenant is accessed using an access token.

When information about a client (hereinafter referred to as “client information”) is required to issue an access token, it is feasible that specific client information is associated in advance with each of all tenants as the client information of the client to which the access token is to be issued.

However, in a case in which specific client information is pre-associated with each of all tenants as client information of a client to which an access token is to be issued, when performing work to change the specific client information that is pre-associated with each of all tenants as client information of a client to which an access token is to be issued to not be client information of a client to which an access token is to be issued, or when changing the content of the specific client information that is pre-associated with each of all tenants as client information of a client to which an access token is to be issued, there is a problem that the number of areas to be worked on is large, resulting in a large amount of work and a high likelihood of operational errors.

Therefore, an object according to the present disclosure is to provide a cloud system, an information processing apparatus, and a program storage medium for a cloud system that can issue an access token using client information that is not pre-associated with a tenant as client information of the client to which the access token is to be issued.

Next, operation of the system 10 in a case in which a user terminal accesses a specific tenant of the service providing system 20 will be described.

Note that in the following, the user terminal 30 will be described as a representative user terminal. However, user terminals other than the user terminal 30 can also perform operations similar to those of the user terminal 30.

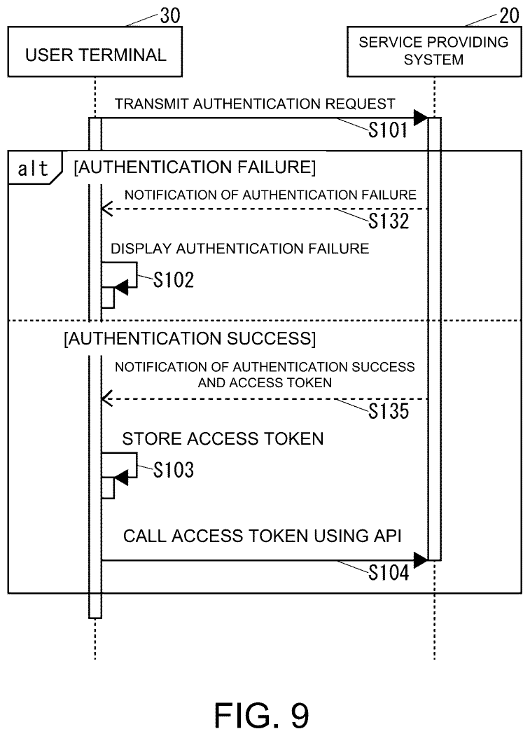

FIG. 9 is a sequence diagram of operation of the system 10 in a case in which the user terminal 30 accesses a specific tenant of the service providing system 20.

A user can instruct the client 35a to access a specific tenant of the service providing system 20 via the operation portion 31 of the user terminal 30. When the client 35a is instructed to access a specific tenant of the service providing system 20, the client 35a transmits a request for execution of an authentication API (hereinafter referred to as an “authentication request”) to the service providing system 20, as shown in FIG. 9 (S101). Here, the client 35a includes the user ID and the user password of the user of the client 35a, and the client ID of the client 35a in the authentication request in S101. In addition, in a case in which a client secret of the client 35a has been set, the client 35a includes the client secret of the client 35a in the authentication request in S101. Note that the user ID and the user password of the user of the client 35a may be input to the client 35a by the user of the client 35a, for example. In addition, the client ID and client secret of the client 35a may be input to the client 35a by, for example, the manufacturer of the client 35a.

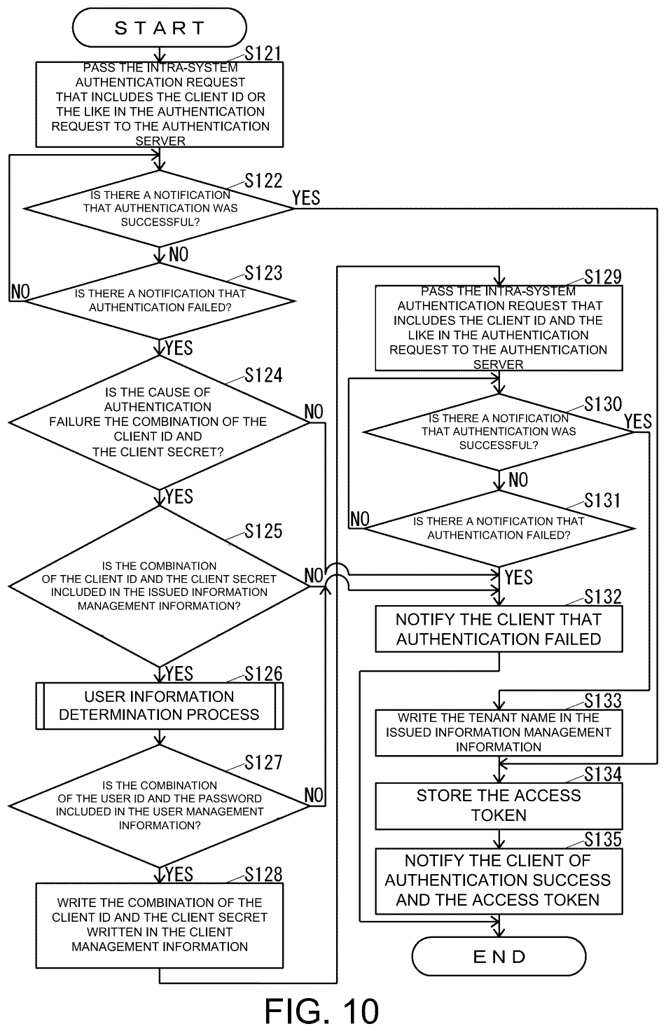

FIG. 10 is a flowchart showing the operation of the API interface portion 25a of the service providing system 20 in a case in which an authentication request is received.

When the service providing system 20 receives the authentication request transmitted by the user terminal 30 in S101, the API interface portion 25a of the service providing system 20 passes a request for authentication within the service providing system 20 (hereinafter referred to as an “intra-system authentication request”) to the authentication server 25b, as shown in FIG. 10 (S121). The API interface portion 25a includes the user ID, the password, and the client ID in the authentication request received from the user terminal 30 in the intra-system authentication request in S121. In addition, in a case in which the authentication request received from the user terminal 30 includes the client secret, the API interface portion 25a also includes the client secret in the authentication request in the intra-system authentication request in S121.

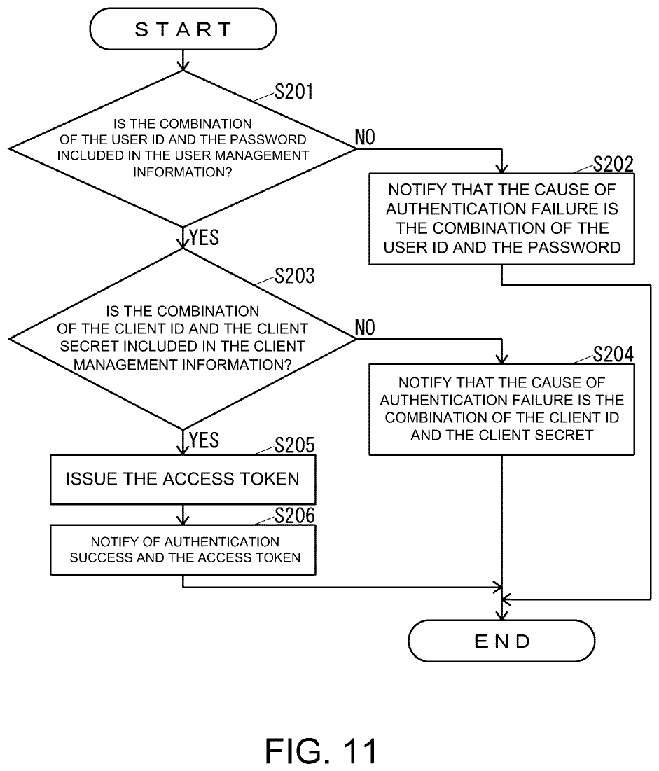

FIG. 11 is a flowchart showing the operation of the authentication server 25b of the service providing system 20 when an intra-system authentication request is received.

When the authentication server 25b of the service providing system 20 receives an intra-system authentication request from the API interface portion 25a, as shown in FIG. 11, the authentication server 25b determines whether or not the combination of the user ID and the password in the intra-system authentication request is associated with the tenant name of the tenant that is the target of the intra-system authentication request and is included in the user management information 24c (S201).

When the authentication server 25b determines in S201 that the combination of the user ID and the password in the intra-system authentication request is not associated with the tenant name of the tenant that is the target of the intra-system authentication request and is not included in the user management information 24c, the authentication server 25b notifies the API interface portion 25a of an authentication failure caused by the combination of the user ID and the password (S202), and terminates the operation shown in FIG. 11.

When the authentication server 25b determines in S201 that the combination of the user ID and the password in the system authentication request is associated with the tenant name of the target tenant of the system authentication request and is included in the user management information 24c, the authentication server 25b determines whether the combination of the client ID and the client secret in the intra-system authentication request is associated with the tenant name of the target tenant of the intra-system authentication request and is included in the client management information 24d (S203). Here, in a case in which the client secret is not included in the intra-system authentication request, when the combination of the client ID in the intra-system authentication request and the fact that the client secret is not set is included in the client management information 24d in association with the tenant name of the tenant that is the target of the intra-system authentication request, the authentication server 25b determines that the combination of the client ID and the client secret in the intra-system authentication request is included in the client management information 24d in association with the tenant name of the tenant that is the target of the intra-system authentication request.

When the authentication server 25b determines in S203 that the combination of the client ID and the client secret in the intra-system authentication request is not associated with the tenant name of the tenant that is the target of the intra-system authentication request and is not included in the client management information 24d, the authentication server 25b notifies the API interface portion 25a of the authentication failure caused by the combination of the client ID and the client secret (S204), and terminates the operation shown in FIG. 11.

When the authentication server 25b determines in S203 that the combination of the client ID and the client secret in the intra-system authentication request is associated with the tenant name of the tenant that is the target of the intra-system authentication request and is included in the client management information 24d, the authentication server 25b issues an access token (S205).

When the process of S205 ends, the authentication server 25b notifies the API interface portion 25a of the success of the authentication and the access token issued in S205 (S206), and ends the operation shown in FIG. 11.

As shown in FIG. 10, when the process of S121 ends, the API interface portion 25a determines whether or not a notification of successful authentication has been received from the authentication server 25b (S122). When the API interface portion 25a receives a notification in S206 (see FIG. 11), the API interface portion 25a determines that the authentication has been successful from the authentication server 25b.

When the API interface portion 25a determines in S122 that there is no notification from the authentication server 25b indicating that authentication was successful, the API interface portion 25a determines whether or not there has been a notification from the authentication server 25b indicating that authentication failed (S123). In a case in which the API interface portion 25a receives the notification in S202 (see FIG. 11) or S204 (see FIG. 11), the API interface portion 25a determines that there has been a notification from the authentication server 25b indicating that authentication has failed.

When the API interface portion 25a determines in S123 that there has been no notification from the authentication server 25b indicating that authentication has failed, the API interface portion 25a executes the process of S122.

When the API interface portion 25a determines in S123 that there was a notification from the authentication server 25b indication that authentication has failed, the API interface portion 25a determines whether the cause of the authentication failure is the combination of the client ID and the client secret (S124). When the API interface portion 25a receives the notification in S204 (see FIG. 11), the API interface portion 25a determines that the cause of the authentication failure is the combination of the client ID and the client secret.

When the API interface portion 25a determines in S124 that the cause of the authentication failure is the combination of the client ID and the client secret, the API interface portion 25a determines via the issued ID management portion 25c whether or not the combination of the client ID and the client secret in the authentication request is included in the issued information management information 24e (S125). Here, in a case in which a client secret is not included in the authentication request, when the combination of the client ID in the authentication request and the fact that the client secret has not been set is included in the issued information management information 24e, the issued ID management portion 25c determines that the combination of the client ID and the client secret in the authentication request is included in the issued information management information 24e.

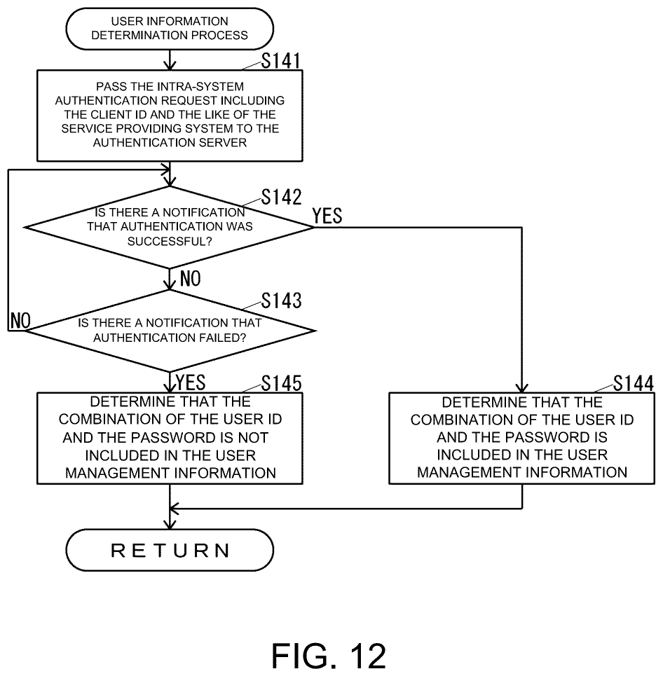

When the API interface portion 25a determines in S125 that the combination of the client ID and the client secret in the authentication request is included in the issued information management information 24e, the API interface portion 25a executes the user information determination process (see FIG. 12) to determine whether or not the combination of the user ID and the password in the authentication request is associated with the tenant name in the authentication request and included in the user management information 24c (S126).

FIG. 12 is a diagram illustrating an example of the user information determination process shown in FIG. 10.

As shown in FIG. 12, the API interface portion 25a passes an intra-system authentication request including the combination of the user ID and the password in the authentication request and the client ID of the service providing system 20 to the authentication server 25b (S141). When the authentication server 25b receives the intra-system authentication request in S141, the authentication server 25b executes the operation shown in FIG. 11.

When the process of S141 ends, the API interface portion 25a determines whether or not a notification has been received from the authentication server 25b indicating that authentication was successful (S142).

When the API interface portion 25a determines in S142 that there was no notification from the authentication server 25b indicating that authentication was successful, the API interface portion 25a determines whether or not there was a notification from the authentication server 25b indicating that the authentication failed (S143).

When the API interface portion 25a determines in S143 that there was no notification from the authentication server 25b indicating that the authentication failed, the API interface portion 25a executes the process of S142.

When the API interface portion 25a determines in S142 that the authentication has been successful from the authentication server 25b, the API interface portion determines that the combination of the user ID and the password in the authentication request is associated with the tenant name in the authentication request and included in the user management information 24c (S144), and terminates the user information determination process shown in FIG. 12.

When the API interface portion 25a determines in S143 that there was a notification from the authentication server 25b indicating that the authentication failed, the API interface portion 25a determines that the combination of the user ID and the password in the authentication request is not associated with the tenant name in the authentication request and is not included in the user management information 24c (S145), and terminates the user information determination process shown in FIG. 12.

As shown in FIG. 10, when the user information determination process of S126 ends, the API interface portion 25a determines whether the combination of the user ID and the password in the authentication request is associated with the tenant name in the authentication request and included in the user management information 24c based on the result of the determination in the user information determination process of S126 (S127).

When the API interface portion 25a determines in S127 that the combination of the user ID and the password in the authentication request is associated with the tenant name in the authentication request and is included in the user management information 24c, the API interface portion 25a writes the combination of the client ID and the client secret in the authentication request to the client management information 24d via the authentication server 25b in association with the tenant name of the tenant that is the target of the authentication request (S128). Here, in a case in which the authentication request does not include a client secret, the API interface portion 25a writes the combination of the client ID in the authentication request and the fact that a client secret has not been set, in association with the tenant name of the tenant that is the target of the authentication request, to the client management information 24d via the authentication server 25b. Note that in a case in which a combination of a client ID and a client secret in the authentication request exists in the client management information 24d in association with the tenant name of the tenant that is the target of the authentication request other than the combination of the client ID and the client secret written in the client management information 24d in S128, the API interface portion 25a, in S128, may delete from the client management information 24d via the authentication server 25b the combination of the client ID and the client secret in the authentication request that exists in the client management information 24d in association with the tenant name of the tenant that is the target of the authentication request other than the combination of the client ID and the client secret written in the client management information 24d in S128.

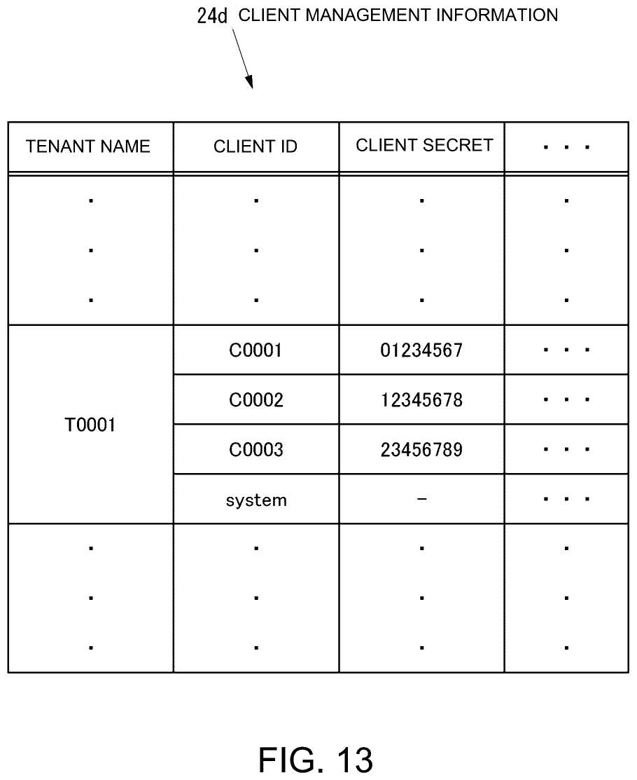

FIG. 13 is a diagram showing an example of the client management information 24d that is different from the example shown in FIG. 5.

For example, when the process of S128 is executed in a case in which the client management information 24d is in the state shown in FIG. 5 and the tenant name of the tenant that is the target of the authentication request is “T0001”, the client ID in the authentication request is “C0002”, and the client secret in the authentication request is “12345678”, the client management information 24d will be in the state shown in FIG. 13.

As shown in FIG. 10, when the process of S128 ends, the API interface portion 25a passes the intra-system authentication request to the authentication server 25b (S129). The API interface portion 25a includes the user ID, the password, and the client ID in the authentication request in the intra-system authentication request in S129. In addition, in a case in which the client secret is included in the authentication request, the API interface portion 25a also includes the client secret in the authentication request in the intra-system authentication request in S129. When the authentication server 25b receives the intra-system authentication request in S129, the authentication server 25b executes the operation shown in FIG. 11.

When the process of S129 ends, the API interface portion 25a determines whether or not a notification indicating that authentication was successful has been received from the authentication server 25b (S130).

When the API interface portion 25a determines in S130 that there was no notification from the authentication server 25b indicating that authentication was successful, the API interface portion 25a determines whether or not there was a notification from the authentication server 25b indicating that authentication failed (S131).

When the API interface portion 25a determines in S131 that there was no notification from the authentication server 25b indicating that authentication failed, the API interface portion 25a executes the process of S130.

When the API interface portion 25a determines in S124 that the cause of the authentication failure is not the combination of the client ID and the client secret, or determines in S125 that the combination of the client ID and the client secret in the authentication request is not included in the issued information management information 24e, or determines in S127 that the combination of the user ID and the password in the authentication request is not associated with the tenant name in the authentication request and included in the user management information 24c, or determines in S131 that there was a notification from the authentication server 25b indicating that authentication failed, the API interface portion 25a notifies the client 35a of the authentication failure (S132) and terminates the operation shown in FIG. 10.

When the API interface portion 25a determines in S130 that there was a notification from the authentication server 25b indicating that authentication was successful, the API interface portion 25a writes the tenant name of the tenant that is the target of the authentication request to the issued information management information 24e via the issued ID management portion 25c in association with the combination of the client ID and the client secret in the authentication request (S133). Here, in a case in which the authentication request does not include a client secret, the API interface portion 25a writes the tenant name of the tenant that is the target of the authentication request into the issued information management information 24e via the issued ID management portion 25c in association with the combination of the client ID in the authentication request and the fact that a client secret has not been set.

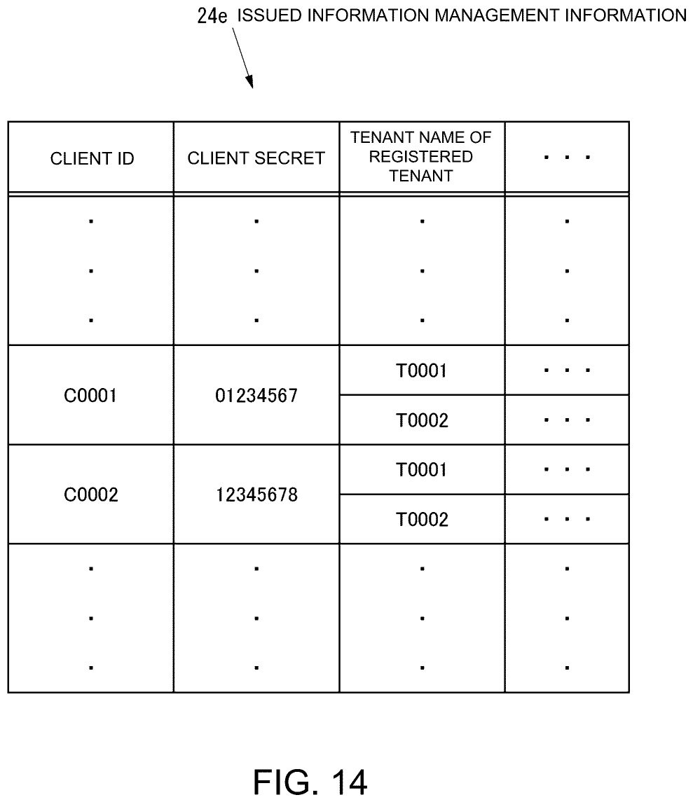

FIG. 14 is a diagram showing an example of the issued information management information 24e that is different from the example shown in FIG. 6.

For example, when the processing of S133 is executed in a case in which the issued information management information 24e is in the state shown in FIG. 6, and the tenant name of the tenant that is the target of the authentication request is “T0001”, the client ID in the authentication request is “C0002”, and the client secret in the authentication request is “12345678”, the issued information management information 24e will be in the state shown in FIG. 14.

As shown in FIG. 10, when the API interface portion 25a determines in S122 that there was a notification from the authentication server 25b indicating that authentication was successful, or when the processing of S133 is completed, the API interface portion 25a stores the access token notified from the authentication server 25b in S206 (see FIG. 11) in response to the processing of S121 or S129 in the token management information 24g in association with the user ID in the authentication request (S134).

When the processing of S134 ends, the API interface portion 25a notifies the client 35a of the success of the authentication and the access token stored in S134 (S135), and ends the operation shown in FIG. 10.

As shown in FIG. 9, when the client 35a is notified of the failure of the authentication by the service providing system 20 in S132, the client 35a displays the failure of the authentication on the display portion 32 (S102).

When the client 35a is notified of successful authentication and the access token from the service providing system 20 in S135, the client 35a stores the access token notified from the service providing system 20 in the storage portion 34 (S103).

When the process of S103 ends, the client 35a executes a call to the service providing system 20 for calling of the API using the access token stored in S103 (S104). Therefore, the service providing system 20 confirms that the access token included in the call in S104 is included in the token management information 24g, and connects the client 35a to the back-end API 25d.

As described above, when an authentication request for access to a specific tenant is transmitted from the client 35a, the service providing system 20 detects that the user information in the authentication request exists in the user management information 24c in association with the tenant that is the target of the authentication request; however, even in a case in which the client information in the authentication request does not exist in client management information 24d in association with the tenant that is the target of the authentication request (YES in S124), when the client information in the authentication request exists in the issued information management information 24e (YES in S125), the service providing system 20 notifies the client 35a of an access token (S135), and therefore can issue an access token using client information that is not previously associated with a tenant as the client information of the client to which the access token is to be issued.

The service providing system 20 can issue an access token by using client information that is not associated in advance with a tenant as client information of a client to which the access token is to be issued. Therefore, the manufacturer of the client 35a does not need to make the behavior of the client 35a different when the client information for the tenant to be accessed by client 35a is not pre-registered in the client management information 24d from the behavior of client 35a when client information for the tenant to be accessed by client 35a is already registered in client management information 24d.

In a case in which the client information in an authentication request for access to a specific tenant does not exist in the client management information 24d in association with the tenant that is the target of the authentication request (YES in S124), the service providing system 20 adds the client information in the authentication request to the client management information 24d in association with the tenant that is the target of the authentication request (S128) when the user information in the authentication request exists in user management information 24c in association with the tenant that is the target of the authentication request (YES in S127) and the client information in the authentication request exists in the issued information management information 24e (YES in S125), and thus is able to improve convenience compared to a configuration in which the user must add client information to client management information 24d.

In the present embodiment, the service providing system 20 passes an intra-system authentication request including the combination of the user ID and the password in the authentication request and the client ID of the service providing system 20 to the authentication server 25b (S141), thereby determining whether the combination of the user ID and the password in the authentication request is associated with the tenant name in the authentication request and included in the user management information 24c. However, the service providing system 20 may use another method to determine whether the combination of the user ID and the password in the authentication request is associated with the tenant name in the authentication request and included in the user management information 24c.

The service providing system 20 can manage access to the API using the client ID. For example, the API interface portion 25a of the service providing system 20 can manage when, who and which client was used to perform access by storing in the storage portion 24 the date and time when the authentication request was received, and the user ID and the client ID in the authentication request in association with each other.

As described above, the cloud system according to the present disclosure, in a case in which the request for accessing the specific tenant is transmitted from the specific client and the user information in the request exists in the user management information in association with the tenant that is the target of the request, when the client information in the request exists in the issued information management information even in a case in which the client information in the request does not exist in the client management information in association with the tenant that is the target of the request, notifies the specific client of the access token, and thus is able to issue the access token by using the client information that is not associated in advance with the tenant as client information of the client to which the access token is to be issued.

The cloud system according to the present disclosure, in a case in which the client information in the request for accessing the specific tenant does not exist in the client management information in association with the tenant that is the target of the request, when the user information in the request exists in the user management information in association with the tenant that is the target of the request, and the client information in the request exists in the issued information management information, adds the client information in the request to the client management information in association with the tenant that is the target of the request, and thus is able to improve convenience as compared to a configuration in which a user must add the client information to the client management information.

The computer that executes the cloud system program according to the present disclosure, in a case in which the request for accessing the specific tenant is transmitted from the specific client and the user information in the request exists in the user management information in association with the tenant that is the target of the request, when the client information in the request exists in the issued information management information even in a case in which the client information in the request does not exist in the client management information in association with the tenant that is the target of the request, notifies the specific client of the access token, and thus is able to issue the access token by using the client information that is not associated in advance with the tenant as client information of the client to which the access token is to be issued.

### Second Embodiment

Hereinafter, a second embodiment according to the present disclosure will be described with reference to the drawings. Note that a description of the configuration common to the first embodiment will be omitted as appropriate.

First, a configuration of a system of the second embodiment according to the present disclosure will be described.

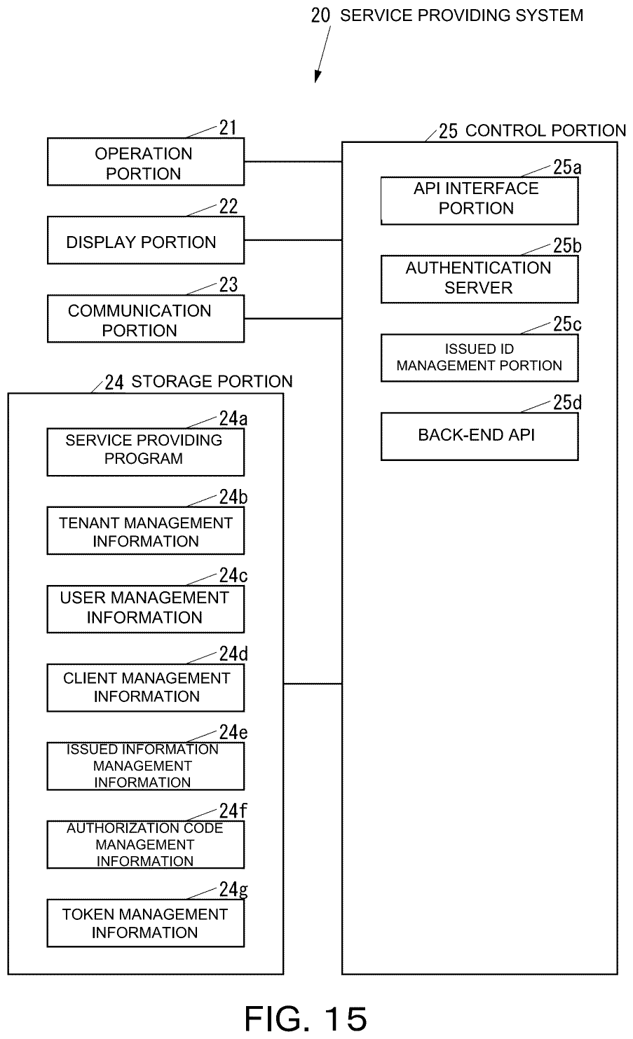

FIG. 15 is a block diagram of a system 10 according to the present embodiment. As shown in FIG. 15, the storage portion 24 can store authorization code management information 24f that manages authorization codes for accessing tenants. The authorization code management information 24f may be configured as a database.

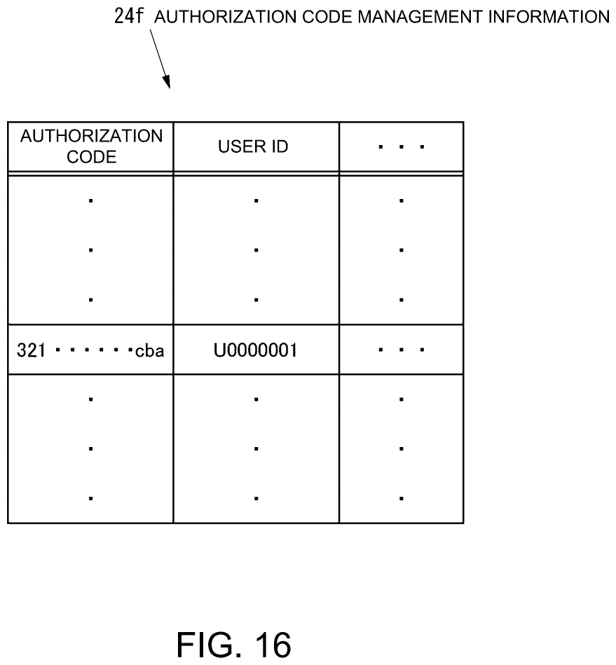

FIG. 16 is a diagram showing an example of the authorization code management information 24f.

As shown in FIG. 16, the authorization code management information 24f includes, for each authorization code, the authorization code and the user ID of the user to which the authorization code applies. The authorization code management information 24f shown in FIG. 16 is shown with some information omitted.

Next, operation of the system 10 in a case in which a user terminal accesses a specific tenant of the service providing system 20 will be described.

Note that in the following, the user terminal 30 will be described as a representative user terminal. However, user terminals other than the user terminal 30 can also perform operations similar to those of the user terminal 30.

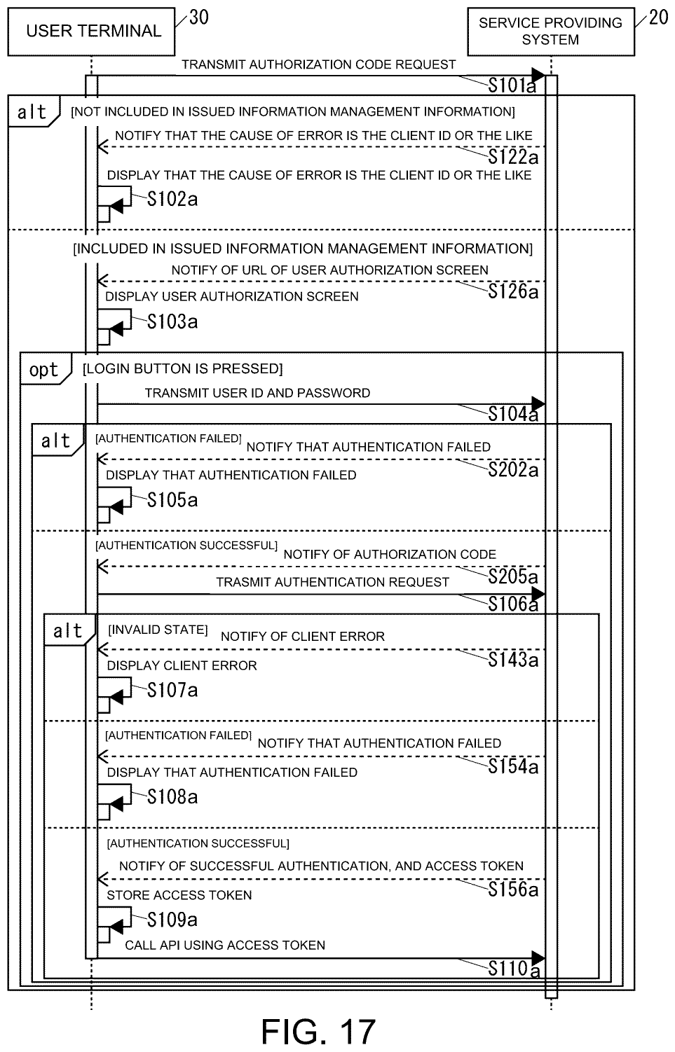

FIG. 17 is a sequence diagram of an operation of the system 10 in a case in which the user terminal 30 accesses a specific tenant of the service providing system 20.

A user can instruct the client 35a to access a specific tenant of the service providing system 20 via the operation portion 31 of the user terminal 30. When the client 35a is instructed to access a specific tenant of the service providing system 20, the client 35a transmits an authorization code request to the service providing system 20 as a request for an authorization code for accessing the specific tenant, as shown in FIG. 17 (S101a). Here, the client 35a includes the client ID of the client 35a in the authorization code request in S101a. In addition, in a case in which the client secret of the client 35a has been set, the client 35a includes the client secret of the client 35a in the authorization code request in S101a. Note that the client ID and the client secret of the client 35a may be input to the client 35a by, for example, the manufacturer of the client 35a. The authorization code request in S101a corresponds to, for example, an authorization request in the authorization code flow or device flow of OAuth 2.0.

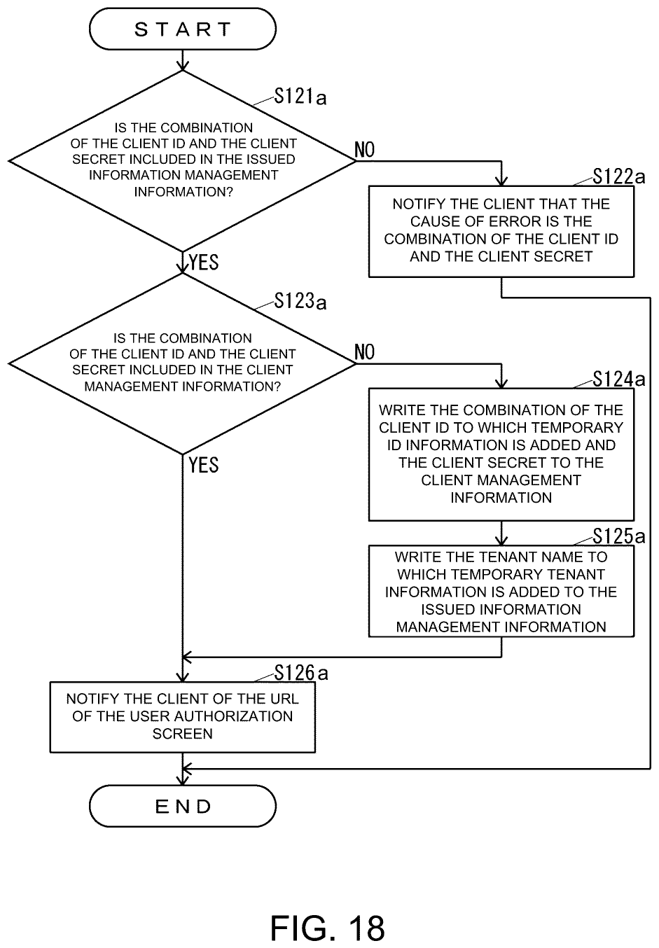

FIG. 18 is a flowchart showing the operation of the API interface portion 25a of the service providing system 20 in a case in which an authorization code request is received.

When the service providing system 20 receives the authorization code request transmitted by the user terminal 30 in S101a, the API interface portion 25a of the service providing system 20 determines via the issued ID management portion 25c whether the combination of the client ID and the client secret in the authorization code request is included in the issued information management information 24e, as shown in FIG. 18 (S121a). Here, in a case in which the client secret is not included in the authorization code request, when the combination of the client ID in the authorization code request and the fact that a client secret is not set is included in the issued information management information 24e, the issued ID management portion 25c determines that the combination of the client ID and the client secret in the authorization code request is included in the issued information management information 24e.

When the API interface portion 25a determines in S121a that the combination of the client ID and the client secret in the authorization code request is not included in the issued information management information 24e, the API interface portion 25a notifies the client 35a of an error caused by the combination of the client ID and the client secret (S122a), and terminates the operation shown in FIG. 18.

As shown in FIG. 17, when the client 35a receives a notification in S122a, the client 35a displays an error caused by the combination of the client ID and the client secret on the display portion 32 (S102a).

As shown in FIG. 18, when the API interface portion 25a determines in S121a that the combination of the client ID and the client secret in the authorization code request is included in the issued information management information 24e, the API interface portion 25a determines via the authentication server 25b whether the combination of the client ID and the client secret in the authorization code request is associated with the tenant name of the tenant that is the target of the authorization code request and is included in the client management information 24d (S123a). Here, in a case in which a client secret is not included in the authorization code request, when the combination of the client ID in the authorization code request and the fact that a client secret is not set is included in the client management information 24d in association with the tenant name of the tenant that is the target of the authorization code request, the authentication server 25b determines that the combination of the client ID and the client secret in the authorization code request is included in the client management information 24d in association with the tenant name of the tenant that is the target of the authorization code request.

When the API interface portion 25a determines in S123a that the combination of the client ID and the client secret in the authorization code request is not included in the client management information 24d in association with the tenant name of the tenant that is the target of the authorization code request, the API interface portion 25a writes the combination of the client ID in the authorization code request to which information indicating that it is a temporary client ID (hereinafter referred to as “temporary ID information”) has been added, and the client secret in the authorization code request, in association with the tenant name of the tenant that is the target of the authorization code request, to the client management information 24d via the authentication server 25b (S124a). Here, in a case in which the authorization code request does not include a client secret, the API interface portion 25a writes the combination of the client ID with the temporary ID information added and the fact that no client secret is set, in association with the tenant name of the tenant that is the target of the authorization code request, to the client management information 24d via the authentication server 25b.

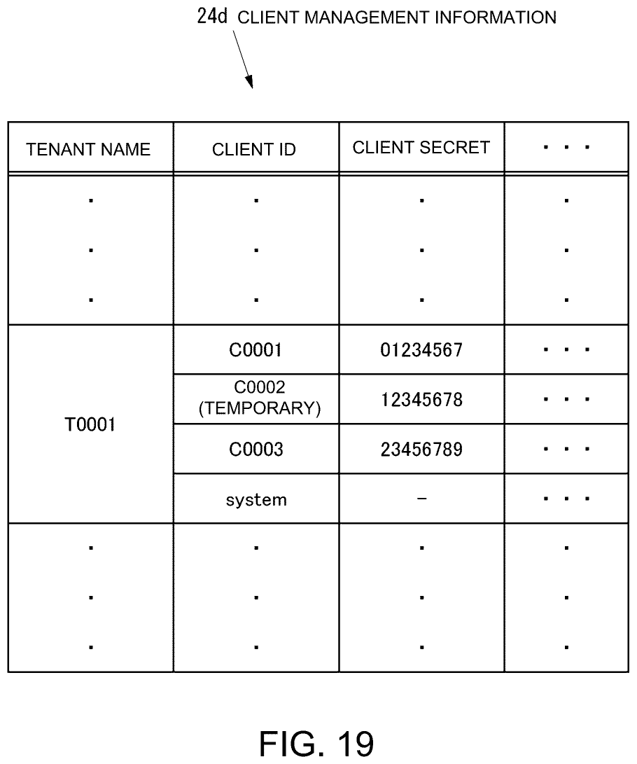

FIG. 19 is a diagram showing an example of the client management information 24d that is different from the examples shown in FIGS. 5 and 13.

For example, when the processing of S124a is executed in a case in which the client management information 24d is in the state shown in FIG. 5, and the tenant name of the tenant that is the target of the authorization code request is “T0001”, the client ID in the authorization code request is “C0002”, and the client secret in the authorization code request is “12345678”, the client management information 24d will be in the state shown in FIG. 19.

In FIG. 19, “C0002 (temporary)” indicates the client ID “C0002” to which the temporary ID information has been added.

As shown in FIG. 18, when the processing of S124a is completed, the API interface portion 25a writes the tenant name of the tenant that is the target of the authorization code request, plus information indicating that the tenant name is a temporary tenant name (hereinafter referred to as “temporary tenant information”), to the issued information management information 24e via the issued ID management portion 25c in association with the combination of the client ID and the client secret in the authorization code request (S125a). Here, in a case in which the authorization code request does not include a client secret, the API interface portion 25a writes the tenant name of the tenant that is the target of the authorization code request, to which temporary tenant information has been added, in association with the combination of the client ID in the authorization code request and the fact that a client secret has not been set, to the issued information management information 24e via the issued ID management portion 25c.

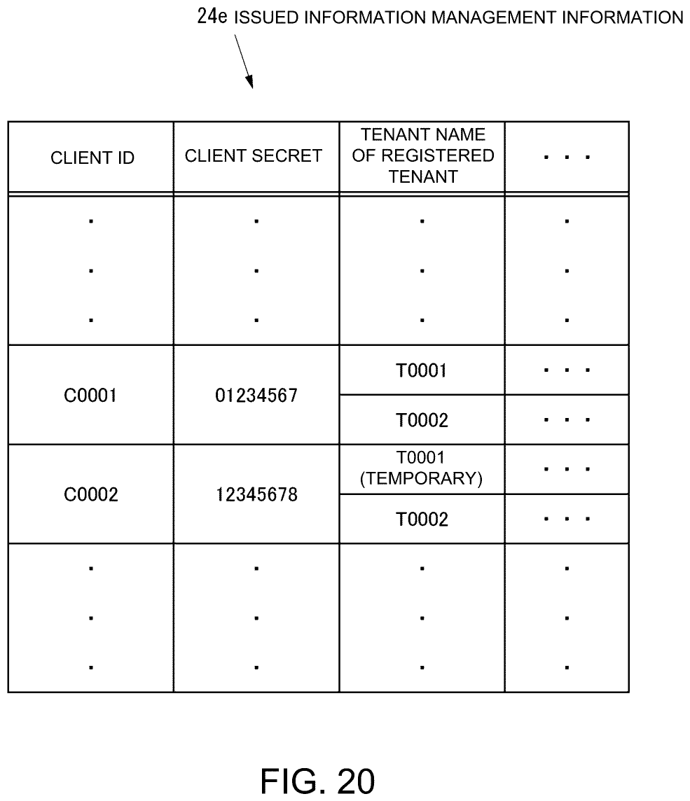

FIG. 20 is a diagram showing an example of the issued information management information 24e that is different from the examples shown in FIG. 6 and FIG. 14.

For example, when the processing of S125a is executed in a case in which the issued information management information 24e is in the state shown in FIG. 6, and the tenant name of the tenant that is the target of the authorization code request is “T0001”, the client ID in the authorization code request is “C0002”, and the client secret in the authorization code request is “12345678”, the issued information management information 24e will be in the state shown in FIG. 20.

In FIG. 20, “T0001 (temporary)” indicates the tenant name “T0001” to which the temporary tenant information has been added.

As shown in FIG. 18, when the API interface portion 25a determines in S123a that the combination of the client ID and the client secret in the authorization code request is associated with the tenant name of the tenant that is the target of the authorization code request and is included in the client management information 24d, or when the processing of S125a is completed, the API interface portion 25a notifies the client 35a of the URL of the user authorization screen as an input screen for user information (S126a), and ends the operation shown in FIG. 18. The user authorization screen is provided by the authentication server 25b.

As shown in FIG. 17, upon receiving the notification in S126a, the client 35a displays the user authorization screen 40 (see, for example, FIG. 14) on the display portion 32 using the URL notified in S126a (S103a).

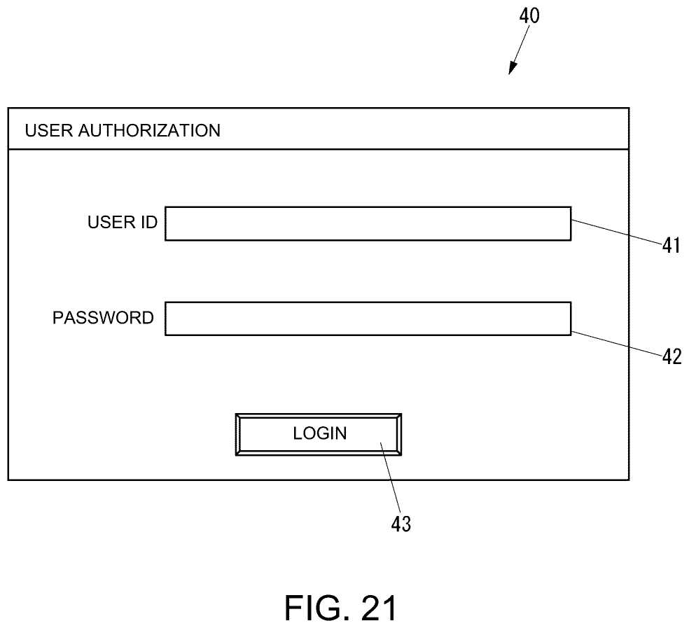

FIG. 21 is a diagram showing an example of the user authorization screen 40.

The user authorization screen 40 shown in FIG. 21 includes a text box 41 for inputting the user ID, a text box 42 for inputting the password, and a login button 43 for instructing login.

As shown in FIG. 17, after the processing of S103a ends, when the login button 43 is pressed on the user authorization screen 40 displayed in S103a, the client 35a transmits to the authentication server 25b a combination of the user ID that was entered in the text box 41 at the time the login button 43 was pressed and the password that was entered in the text box 42 at the time the login button 43 was pressed (S104a).

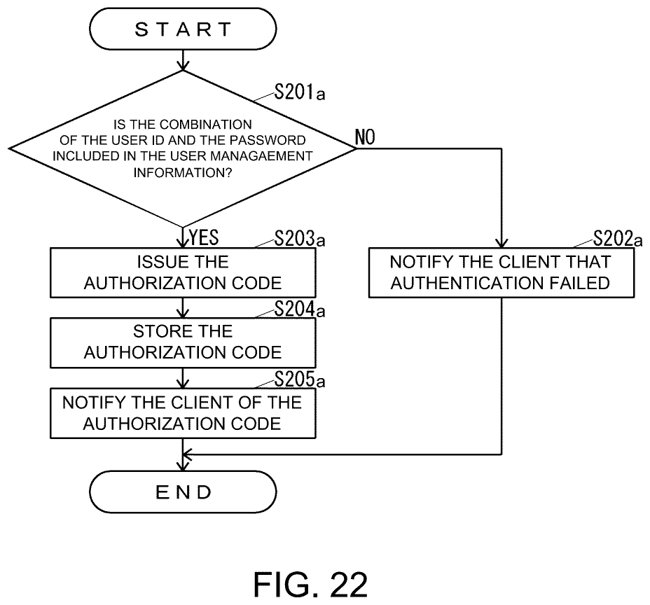

FIG. 22 is a flowchart showing the operation of the authentication server 25b of the service providing system 20 when a combination of the user ID and the password is received.

When the authentication server 25b receives the combination of the user ID and the password sent from the client 35a in S104a, the authentication server 25b determines whether the combination of the user ID and the password received from the client 35a is included in the user management information 24c in association with the tenant name of the tenant that is the target of the authorization code request, or in other words, the target tenant on the user authorization screen 40, as shown in FIG. 22 (S201a).

When the authentication server 25b determines in S201a that the combination of user ID and the password received from the client 35a is not associated with the tenant name of the target tenant on the user authorization screen 40 and is not included in the user management information 24c, the authentication server 25b notifies the client 35a that authentication failed due to the combination of user ID and the password (S202a), and terminates the operation shown in FIG. 22.

As shown in FIG. 17, when the client 35a receives the notification in S202a, the client 35a displays on the display portion 32 the fact that the authentication has failed due to the combination of the user ID and the password (S105a).

As shown in FIG. 22, when the authentication server 25b determines in S201a that the combination of user ID and the password received from the client 35a is associated with the tenant name of the target tenant on the user authorization screen 40 and is included in the user management information 24c, the authentication server 25b issues an authorization code (S203a).

When the process of S203a is completed, the authentication server 25b stores the authorization code issued in S203a in the authorization code management information 24f in association with the user ID received from the client 35a (S204a).

When the process of S204a is completed, the authentication server 25b notifies the client 35a of the authorization code issued in S203a (S205a), and ends the operation shown in FIG. 22.

As shown in FIG. 17, upon receiving the notification in S205a, the client 35a transmits an authentication request to the service providing system 20 (S106a). The client 35a includes the authorization code notified in S205a and the client ID in the authorization code request in the authentication request in S106a. In addition, in a case in which a client secret is included in the authorization code request, the client 35a also includes the client secret in the authorization code request in the authentication request in S106a.

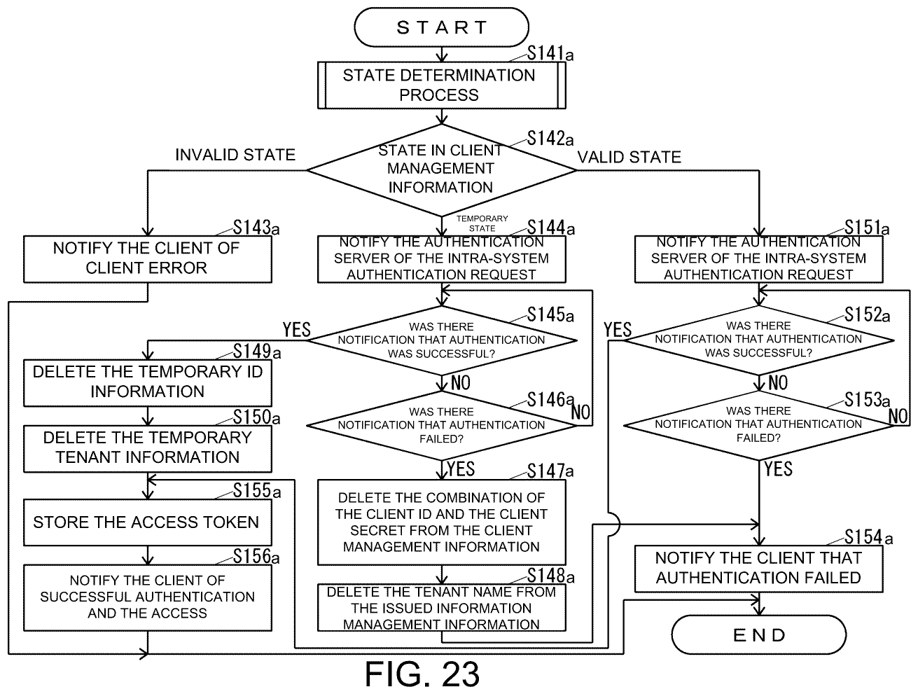

FIG. 23 is a flowchart showing operation of the API interface portion 25a of the service providing system 20 when an authentication request is received.

When the API interface portion 25a of the service providing system 20 receives the authentication request transmitted in S106a, the API interface portion 25a executes a state determination process to determine the state in the client management information 24d of the combination of the client ID and the client secret in the authentication request, as shown in FIG. 23 (S141a).

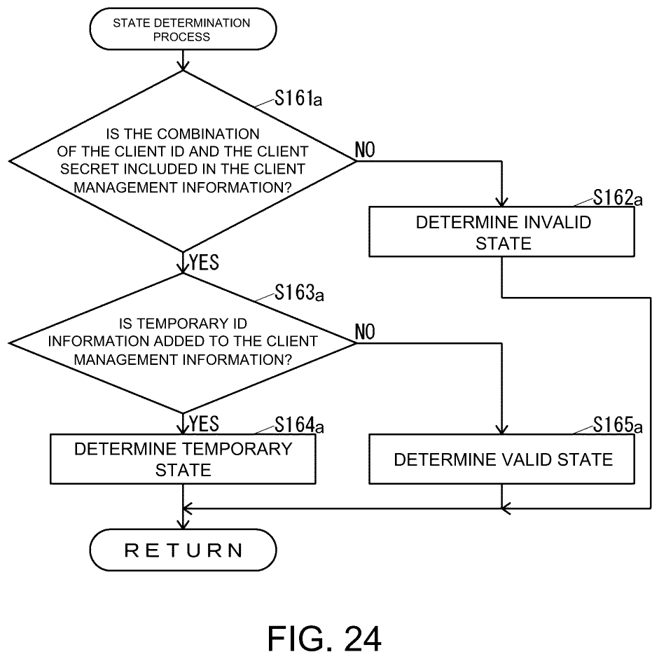

FIG. 24 is a diagram showing an example of a state determination process shown in FIG. 23.

As shown in FIG. 24, the API interface portion 25a determines, via the authentication server 25b, whether the combination of the client ID and the client secret in the authentication request is associated with the tenant name of the tenant that is the target of the authentication request and is included in the client management information 24d (S161a). Here, in a case in which a client secret is not included in the authentication request, and when the combination of the client ID in the authentication request and the fact that a client secret has not been set is associated with the tenant name of the tenant that is the target of the authentication request and is included in the client management information 24d, the authentication server 25b determines that the combination of the client ID and the client secret in the authentication request is associated with the tenant name of the tenant that is the target of the authentication request and is included in the client management information 24d.

When the API interface portion 25a determines in S161a that the combination of the client ID and the client secret in the authentication request is not associated with the tenant name of the tenant that is the target of the authentication request and is not included in the client management information 24d, the API interface portion 25a determines the state of the combination of the client ID and the client secret in the authentication request in the client management information 24d as an invalid state (S162a), and terminates the state determination process shown in FIG. 24.

When the API interface portion 25a determines in S161a that the combination of the client ID and the client secret in the authentication request is associated with the tenant name of the tenant that is the target of the authentication request and is included in the client management information 24d, the API interface portion 25a determines via the authentication server 25b whether temporary ID information is added in the client management information 24d to the client ID of the combination of the client ID and the client secret in the authentication request, which is associated with the tenant name of the tenant that is the target of the authentication request and is included in the client management information 24d (S163a).

When the API interface portion 25a determines in S163a that temporary ID information is added in the client management information 24d to the client ID of the combination of the client ID and the client secret in the authentication request, which is associated with the tenant name of the tenant that is the target of the authentication request and is included in the client management information 24d, the API interface portion 25a determines that the state of the combination of the client ID and the client secret in the authentication request in the client management information 24d is a temporary state (S164a), and terminates the state determination process shown in FIG. 24.

When the API interface portion 25a determines in S163a that temporary ID information is not added to the client ID of the combination of the client ID and the client secret in the authentication request, which is included in the client management information 24d in association with the tenant name of the tenant that is the target of the authentication request, in the client management information 24d, the API interface portion 25a determines the state of the combination of the client ID and the client secret in the authentication request in the client management information 24d as a valid state (S165a), and terminates the state determination process shown in FIG. 24.

As shown in FIG. 23, when the state determination process of S141a is completed, the API interface portion 25a determines the state in the client management information 24d of the combination of the client ID and the client secret in the authentication request based on the result of the state determination process of S141a (S142a).

When the API interface portion 25a determines in S142a that the state of the combination of the client ID and the client secret in the authentication request in the client management information 24d is invalid, the API interface portion 25a notifies the client 35a of an error indicating that the client is an unauthorized client (hereinafter referred to as a “client error”) (S143a), and terminates the operation shown in FIG. 23.

As shown in FIG. 17, when the client 35a is notified of the client error from the service providing system 20 in S143a, the client 35a displays the client error on the display portion 32 (S107a).

As shown in FIG. 23, when the API interface portion 25a determines in S142a that the state of the combination of the client ID and the client secret in the authentication request in the client management information 24d is temporary, the API interface portion 25a notifies the authentication server 25b of a request for authentication within the service providing system 20 (hereinafter referred to as an “intra-system authentication request”) (S144a). The API interface portion 25a includes the authorization code and the client ID in the authentication request in the intra-system authentication request in S144a. In addition, in a case in which the client secret is not included in the authentication request, the API interface portion 25a includes information indicating that the client secret does not exist in the intra-system authentication request in S144a, and in a case in which the client secret is included in the authentication request, the API interface portion 25a includes the client secret in the authentication request in the intra-system authentication request in S144a.

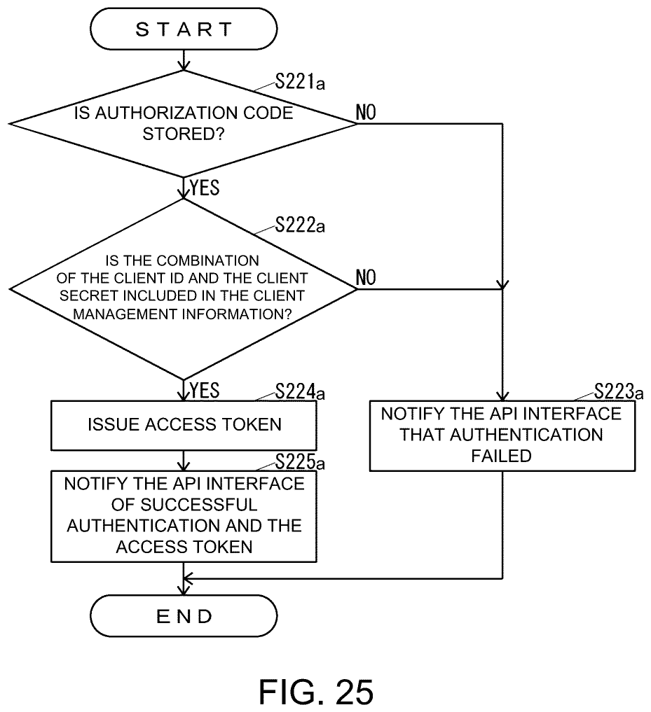

FIG. 25 is a flowchart of the operation of the authentication server 25b of the service providing system 20 in a case in which an intra-system authentication request is received.

When the authentication server 25b receives the intra-system authentication request, as shown in FIG. 25, the authentication server 25b determines whether or not the authorization code in the intra-system authentication request is stored in the authorization code management information 24f (S221a).

When the authentication server 25b determines in S221a that the authorization code in the intra-system authentication request is stored in the authorization code management information 24f, the authentication server 25b determines whether the combination of the client ID and the client secret in the intra-system authentication request is associated with the tenant name of the tenant that is the target of the intra-system authentication request and is included in the client management information 24d (S222a). Here, in a case in which the client secret is not included in the intra-system authentication request, when the combination of the client ID in the intra-system authentication request and the fact that the client secret is not set is included in the client management information 24d in association with the tenant name of the tenant that is the target of the intra-system authentication request, the authentication server 25b determines that the combination of the client ID and the client secret in the intra-system authentication request is included in the client management information 24d in association with the tenant name of the tenant that is the target of the intra-system authentication request.

When the authentication server 25b determines in S221a that the authorization code in the intra-system authentication request is not stored in the authorization code management information 24f, or determines in S222a that the combination of the client ID and the client secret in the intra-system authentication request is not associated with the tenant name of the tenant that is the target of the intra-system authentication request and is not included in the client management information 24d, the authentication server 25b notifies the API interface portion 25a that authentication failed (S223a) and terminates the operation shown in FIG. 25.

When the authentication server 25b determines in S222a that the combination of the client ID and the client secret in the intra-system authentication request is associated with the tenant name of the tenant that is the target of the intra-system authentication request and is included in the client management information 24d, the authentication server 25b issues an access token (S224a).

When the processing of S224a is completed, the authentication server 25b notifies the API interface portion 25a of the success of the authentication and the access token issued in S224a (S225a), and ends the operation shown in FIG.

As shown in FIG. 23, when the processing of S144a is completed, the API interface portion 25a determines whether or not a notification has been received from the authentication server 25b indicating that authentication was successful (S145a). In a case in which the API interface portion 25a receives the notification in S225a (see FIG. 25), the API interface portion 25a determines that there was a notification from the authentication server 25b indicating that the authentication was successful.

When the API interface portion 25a determines in S145a that there is no notification from the authentication server 25b indicating that authentication was successful, the API interface portion 25a determines whether or not there was a notification from the authentication server 25b indicating that the authentication failed (S146a). When the API interface portion 25a has received the notification in S223a (see FIG. 25), the API interface portion 25a determines that there was a notification from the authentication server 25b indicating that the authentication has failed.

When the API interface portion 25a determines in S146a that there was no notification from the authentication server 25b indicating that authentication failed, the API interface portion 25a executes the process of S145a.

When the API interface portion 25a determines in S146a that the there was no notification from the authentication server 25b indicating that authentication failed, the API interface portion 25a deletes from the client management information 24d the combination of the client ID and the client secret in the authentication request that is associated with the tenant name of the tenant that is the target of the authentication request and is included in the client management information 24d (S147a).

For example, when the processing of S147a is executed in a case in which the client management information 24d is in the state shown in FIG. 19, and the tenant name of the tenant that is the target of the authentication request is “T0001”, the client ID in the authentication request is “C0002”, and the client secret in the authentication request is “12345678”, the client management information 24d will be in the state shown in FIG. 5.

As shown in FIG. 23, when processing of S147a is completed, the API interface portion 25a deletes from the issued information management information 24e the tenant name of the tenant that is the target of the authentication request, which is included in the issued information management information 24e in association with the combination of the client ID and the client secret in the authentication request (S148a).

For example, when the processing of S148a is executed in a case in which the issued information management information 24e is in the state shown in FIG. 20, and the tenant name of the tenant that is the target of the authentication request is “T0001”, the client ID in the authentication request is “C0002”, and the client secret in the authentication request is “12345678”, the issued information management information 24e will be in the state shown in FIG. 6.

As shown in FIG. 23, when the API interface portion 25a determines in S145a that there was a notification from the authentication server 25b indicating that the authentication was successful, the API interface portion 25a deletes the temporary ID information attached to the client ID of the combination of the client ID and the client secret in the authentication request, which is included in the client management information 24d in association with the tenant name of the tenant that is the target of the authentication request (S149a). That is, the API interface portion 25a leaves the combination of the client ID and the client secret in the authentication request, which is included in the client management information 24d in association with the tenant name of the tenant that is the target of the authentication request, in the client management information 24d as formal client information. Note that in a case in which a combination of a client ID and a client secret in the authentication request exists in the client management information 24d in association with the tenant name of the tenant that is the target of the authentication request other than the combination of the client ID and the client secret in the authentication request, the API interface portion 25a may in S149a delete from the client management information 24d via the authentication server 25b the combination of the client ID and the client secret in the authentication request other than the combination of the client ID and the client secret in the authentication request that exists in the client management information 24d in association with the tenant name of the tenant that is the target of the authentication request.

FIG. 13 is a diagram showing an example of the client management information 24d that is different from the examples shown in FIGS. 5 and 19.

For example, when the processing of S149a is executed in a state in which the client management information 24d is in the state shown in FIG. 19, and the tenant name of the tenant that is the target of the authentication request is “T0001”, the client ID in the authentication request is “C0002”, and the client secret in the authentication request is “12345678”, the client management information 24d will be in the state shown in FIG. 13.

As shown in FIG. 23, when processing of S149a is completed, the API interface portion 25a deletes, via the issued ID management portion 25c, the temporary tenant information that is added to the tenant name of the tenant that is the target of the authentication request and that is included in the issued information management information 24e in association with the combination of the client ID and the client secret in the authentication request (S150a). Here, in a case in which the authentication request does not include a client secret, the API interface portion 25a deletes, via the issued ID management portion 25c, the temporary tenant information that is added to the tenant name of the tenant that is the target of the authentication request and that is included in the issued information management information 24e in association with the combination of the client ID in the authentication request and the fact that a client secret is not set.

FIG. 14 is a diagram showing an example of the issued information management information 24e that is different from the examples shown in FIG. 6 and FIG. 20.

For example, when the processing of S150a is executed in a case in which the issued information management information 24e is in the state shown in FIG. 20, and the tenant name of the tenant that is the target of the authentication request is “T0001”, the client ID in the authentication request is “C0002”, and the client secret in the authentication request is “12345678”, the issued information management information 24e will be in the state shown in FIG. 14.

As shown in FIG. 23, when the API interface portion 25a determines in S142a that the state of the combination of the client ID and the client secret in the authentication request in the client management information 24d is valid, the API interface portion 25a notifies the authentication server 25b of the intra-system authentication request (S151a), similar to the processing of S144a. Therefore, the authentication server 25b executes the operation shown in FIG. 25.

As shown in FIG. 23, when the process of S151a is completed, the API interface portion 25a determines whether or not a notification has been received from the authentication server 25b indicating that authentication was successful (S145a). In a case in which the API interface portion 25a receives the notification in S225a (see FIG. 25), the API interface portion 25a determines that there was a notification from the authentication server 25b indicating that the authentication was successful.

When the API interface portion 25a determines in S152a that there is no notification from the authentication server 25b indicating that authentication was successful, the API interface portion 25a determines whether or not there was a notification from the authentication server 25b indicating that the authentication failed (S153a). When the API interface portion 25a has received the notification in S223a (see FIG. 25), the API interface portion 25a determines that there was a notification from the authentication server 25b indicating that the authentication has failed.

When the API interface portion 25a determines in S153a that there was no notification from the authentication server 25b indicating that authentication failed, the API interface portion 25a executes the process of S152a.

When the API interface portion 25a determines in S153a that the processing of S148a is completed or that there was a notification from the authentication server 25b indicating that the authentication has failed, the API interface portion 25a notifies the client 35a of the authentication failure (S154a) and ends the operation shown in FIG. 23.

As shown in FIG. 17, upon receiving the notification in S154a, the client 35a displays the authentication failure on the display portion 32 (S108a).

As shown in FIG. 23, when the API interface portion 25a determines in S152a that the processing of S150a is completed or that there was a notification from the authentication server 25b indicating that authentication was successful, the API interface portion 25a stores the access token notified from the authentication server 25b in the token management information 24g in association with the user ID in the authentication request (S155a).

When the processing of S155a is completed, the API interface portion 25a notifies the client 35a of the success of the authentication and the access token stored in S155a (S156a), and ends the operation shown in FIG. 23.

As shown in FIG. 17, upon receiving the notification in S156a, the client 35a stores the access token notified from the service providing system 20 in the storage portion 34 (S109a).

When the process of S109a is completed, the client 35a executes a call to the service providing system 20 for calling of the API using the access token stored in S109a (S110a). Therefore, the service providing system 20 confirms that the access token included in the call in S110a is included in the token management information 24g, and connects the client 35a to the backend API 25d.

As described above, in a case in which an authorization code request for accessing a specific tenant is transmitted from the client 35a, even in a case in which the client information in the authorization code request does not exist in the client management information 24d in association with the target tenant of the authorization code request (NO in S123a), when the client information in the authorization code request exists in the issued information management information 24e (YES in S121a), the service providing system 20 notifies the client 35a of the URL of the user authorization screen 40 (S126a), and in a case in which the user information entered on the user authorization screen 40 exists in the user management information 24c in association with the target tenant of the authorization code request (YES in S145a), the service providing system 20 notifies the client 35a of an access token (S156a), and thus it is possible to issue an access token using client information that is not previously associated with a tenant as the client information of the client to which the access token is to be issued.

The service providing system 20 can issue an access token by using client information that is not associated in advance with a tenant as client information of a client to which the access token is to be issued. Therefore, the manufacturer of the client 35a does not need to make the behavior of the client 35a different when the client information for the tenant to be accessed by client 35a is not pre-registered in the client management information 24d from the behavior of client 35a when client information for the tenant to be accessed by client 35a is already registered in client management information 24d.

In a case in which the client information in the authorization code request for accessing a specific tenant does not exist in the client management information 24d in association with the tenant that is the target of the authorization code request (NO in S123a), and the client information in the authorization code request exists in the issued information management information 24e (YES in S121a) and the user information entered on the user authorization screen 40 exists in the user management information 24c in association with the tenant that is the target of the authorization code request (YES in S145a), the service providing system 20 adds the client information in the authorization code request to the client management information 24d in association with the tenant that is the target of the authorization code request (S149a), and thus it is possible to improve convenience compared to a configuration in which the user must add client information to the client management information 24d.

The service providing system 20 can manage access to the API using the client ID. For example, the API interface portion 25a of the service providing system 20 can manage when, who and which client was used to perform access by storing in the storage portion 24 the date and time when the authentication request was received, and the user ID and the client ID in the authentication request in association with each other.

As described above, the cloud system according to the present disclosure, in a case in which a request for accessing a specific tenant is sent from a specific client, even if the client information in the request does not exist in client management information in association with the tenant that is the target of the request, when the client information in the request exists in the issued information management information, notifies the specific client of the URL of the user information input screen, and in a case in which the user information entered on the input screen exists in user management information in association with the tenant that is the target of the request, notifies the specific client of an access token, and thus is able to issue the access token by using the client information that is not associated in advance with the tenant as client information of the client to which the access token is to be issued.

The cloud system according to the present disclosure, in a case in which client information in a request for accessing a specific tenant does not exist in the client management information corresponding to the tenant that is the target of the request, and when the client information in the request exists in the issued information management information and the user information entered on a user information input screen exists in the user management information corresponding to the tenant that is the target of the request, adds the client information in the request to the client management information corresponding to the tenant that is the target of the request, and thus is able to improve convenience as compared to a configuration in which a user must add the client information to the client management information.

The computer that executes the cloud system program according to the present disclosure, in a case in which a request for accessing a specific tenant is sent from a specific client, even if the client information in the request does not exist in client management information in association with the tenant that is the target of the request, when the client information in the request exists in the issued information management information, notifies the specific client of the URL of the user information input screen, and in a case in which the user information entered on the input screen exists in user management information in association with the tenant that is the target of the request, notifies the specific client of an access token, and thus is able to issue the access token by using the client information that is not associated in advance with the tenant as client information of the client to which the access token is to be issued.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A cloud system that uses
user management information for managing user information as information about users for each tenant;
client management information for managing client information as information about a client for each tenant; and
issued information management information for managing the issued client information; and is configured to
notify a specific client of an access token in a case in which a request for accessing a specific tenant is transmitted from the specific client and when the user information in the request exists in the user management information in association with the tenant that is a target of the request and the client information in the request exists in the client management information in association with the tenant that is the target of the request; and
notify the specific client of the access token when the client information in the request exists in the issued information management information even in a case in which the user information in the request exists in the user management information in association with the tenant that is the target of the request, but the client information in the request does not exist in the client management information in association with the tenant that is the target of the request.

2. The cloud system according to claim 1, wherein
in a case in which the client information in the request does not exist in the client management information in association with the tenant that is the target of the request, and when the user information in the request exists in the user management information in association with the tenant that is the target of the request, and the client information in the request exists in the issued information management information, adds the client information in the request to the client management information in association with the tenant that is the target of the request.

3. A cloud system that uses
user management information for managing user information as information about users for each tenant;
client management information for managing client information as information about a client for each tenant; and
issued information management information for managing the issued client information; and is configured to
notify the specific client of a URL of an input screen for the user information in a case in which a request for accessing the specific tenant is transmitted from the specific client and the client information in the request exists in the client management information in association with the tenant that is the target of the request;
notify the specific client of the URL in a case in which the client information in the request exists in the issued information management information even when the client information in the request does not exist in the client management information in association with the tenant that is the target of the request; and
notify the specific client of an access token in a case in which the user information entered on the input screen exists in the user management information in association with the tenant that is the target of the request.

4. The cloud system according to claim 3, wherein
in a case in which the client information in the request does not exist in the client management information in association with the tenant that is the target of the request, and when the client information in the request exists in the issued information management information, and the user information entered on the input screen exists in the user management information in association with the tenant that is the target of the request, adds the client information in the request to the client management information in association with the tenant that is the target of the request.
